(19) United States
(12) Patent Application Publication
(10) Pub. No.: US 2021/0403339 A1
(43) Pub. Date: Dec. 30, 2021

(54) PREPARATION OF TITANIUM DIOXIDE

(71) Applicant: TNG LIMITED, SUBIACO, Western Australia (AU)

(72) Inventor: Damian Edward Gerard CONNELLY, PERTH, Western Australia (AU)

(73) Assignee: TNG LIMITED, SUBIACO, Western Australia (AU)

(21) Appl. No.: 17/291,106

(22) PCT Filed: Nov. 7, 2019
(86) PCT No.: PCT/AU2019/051223

§ 371 Date: May 4, 2021

(30) Foreign Application Priority Data
Nov. 7, 2018 (AU) 2018904247

(51) Int. Cl. C01G 23/053; C01G 23/08

(52) U.S. Cl. CPC C01G 23/053; C01G 23/08

(57) ABSTRACT

A method for the preparation of titanium dioxide, the method comprising the steps of subjecting a titanium containing leach residue to a concentrated sulfuric acid digest step; and in turn subjecting that residue to a leach in dilute sulfuric acid, whereby a black liquor is obtained and from which titanium dioxide is in turn obtained.

### FIELD OF THE INVENTION

The present invention relates to a method for the preparation of titanium dioxide. More particularly, the titanium dioxide prepared by the method of the present invention is intended to be utilised in the preparation of a titanium dioxide pigment.

Still more particularly, the method of the present invention utilises as a starting material the residue from a leach of a titanomagnetite-type ore.

### BACKGROUND ART

International Patent Application PCT/AU2011/000519 (WO 2011/143689) by the present Applicant describes a novel hydrometallurgical process for extracting vanadium from titanomagnetite-type ores. The process described in Application PCT/AU2011/000519 utilises a combination of acid leaching, solvent extraction and stripping to selectively recover valuable metals. Application PCT/AU2011/000519 further describes a leach feed material comprising an amount of iron, wherein said iron is co-extracted with vanadium. Iron is co-extracted with vanadium in the acid leaching step since vanadium is locked within the titanomagnetite matrix. The iron is then carried along with the vanadium to the solvent extraction and stripping stages to be subsequently removed.

Minimising the amount of iron or any other gangue material in the leach feed material is beneficial for improving the overall extraction and recovery of vanadium. Furthermore, improving the quality of the leach feed material minimises operating costs and capital expenditure, as additional process steps for handling significant amounts of iron downstream after the leach step are substantially avoided.

International Patent Application PCT/AU2018/050310 (WO 2018/184067), also by the present Applicant, describes a method for preparing a leach feed material, the method comprising the steps of first passing an ore or concentrate containing vanadium and iron to a reduction step to form a reduced ore or concentrate, and subsequently passing the reduced ore or concentrate to a ferric leach step to produce a ferric leachate containing iron and a ferric leach residue containing vanadium, wherein the ferric leach residue is suitable for use as the leach feed material for extracting and recovering vanadium.

International Patent Application PCT/AU2018/050310 further describes passing the ferric leach residue to an acid leach step, from which is produced both an acid leachate containing vanadium, and an acid leach residue that contains titanium. The acid leach step is conducted using hydrochloric (HCl) acid, in a concentration of between about 15% to 32% (w/w), and preferably between about 15% to 20% (w/w). The acid leach step is conducted under atmospheric pressure and at a temperature ranging between about 25° C. to 100° C. Preferably, the temperature ranges between about 60° C. to 80° C.

The flowsheets described in both International Patent Applications PCT/AU2011/000519 and PCT/AU2018/050310 produce a pressure leach residue which is high in titanium. The Applicants have identified that such a leach residue may be a potential feedstock to a titanium pigment plant. The leach residue is, however, significantly finer than traditional feedstocks, and is higher in silica which can be expected to adversely impact the efficiency of a standard or known pigment plant chlorinator.

The method of the present invention has as one object thereof to overcome substantially the abovementioned problems of the prior art, or to at least provide a useful alternative thereto.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “contain” or variations such as “contains” or “containing”, will be understood to imply the inclusion of a stated integer or group of integers but not the exclusion of any other integer or group of integers.

Each document, reference, patent application or patent cited in this text is expressly incorporated herein in their entirely by reference, which means that it should be read and considered by the reader as part of this text. That the document, reference, patent application, or patent cited in this text is not repeated in this text is merely for reasons of brevity.

Reference to cited material or information contained in the text should not be understood as a concession that the material or information was part of the common general knowledge or was known in Australia or any other country either at the time of filing of this application or any application from which priority may be claimed.

### DISCLOSURE OF THE INVENTION

In accordance with the present invention there is provided a method for the preparation of titanium dioxide, the method comprising the steps of:
(i) Subjecting a titanium containing leach residue to a concentrated sulfuric acid digest step; and
(ii) In turn subjecting that residue to a leach in dilute sulfuric acid,
   whereby a black liquor is obtained and from which titanium dioxide is in turn obtained.

Preferably, the titanium dioxide prepared by the method of the present invention is utilised in the preparation of a titanium dioxide pigment.

Still preferably, the method of the present invention utilises as a starting material the residue from a leach of a titanomagnetite-type ore. The leach of the titanomagnetite-type ore is preferably conducted using hydrochloric acid. Preferably, the concentration of HCl acid ranges between:
a. about 15% to 32% (w/w); or.
b. about 15% to 20% (w/w).

Preferably, a feedstock for the leach of the titanomagnetite-type ore is the product of a ferric leach. The ferric leach step is preferably conducted with ferric chloride. Preferably, the concentration of ferric chloride ranges between:
a. about 10 to 40% w/w;
b. about 25 to 35% w/w; or
c. about 28% w/w.

Preferably, the titanium containing leach residue has a P₈₀ of:
a. ≤125 μm;
b. ≤45 μm; or
c. <40 μm.

In one form of the present invention, recovery of titanium into the black liquor is at least 98%.

Preferably, the digest step is conducted at a temperature of:
a. greater than 175° C.; or
b. about 190° C.

Preferably, the digest step is conducted over a period of:
a. Between about 3 to 4 hours; or
b. About 3 hours.

Still preferably, the mix of leach residue to concentrated sulfuric acid in the digest step is in the ratio of about 1:1.27 (g/g).

Preferably, at least 1.9 g of concentrated H₂SO₄ is provided in the digest step (i) for every gram of TiO₂ in the titanium containing leach residue.

Preferably, the dilute sulfuric acid of the leach step (ii) is about 6% sulfuric acid.

Still preferably, the leach step (ii) is conducted at about 60° C.

Preferably, the leach step (ii) is conducted for a period of about 15 hours.

Still further preferably, the leach step (ii) is conducted at about 20% solids.

Preferably, black liquor is recovered from a slurry produced by the leach step (ii) by filtration and the solids washed to recover titanium.

In one form of the present invention the digest step proceeds in an autothermic manner.

In a further form of the present invention the digest step further comprises an initial dilution of the acid. Preferably, the acid is diluted to about 88-92% with water.

### DESCRIPTION OF THE DRAWINGS

The present invention will now be described, by way of example only, with reference to an embodiment thereof and the accompanying drawings, in which:—

FIG. 1 is a graph of an initiation temperature trial conducted in a large furnace, showing sample heating rate relative to that of the furnace control thermocouple;

FIG. 2 is a graph of an initiation temperature trial conducted in a smaller fan forced oven with a rapid temperature response, again showing sample heating rate relative to that of the furnace control thermocouple; and

FIG. 3 is a graph of the differential scanning calorimetry of ilmenite and pressure leach residue, showing exothermic reactions therein upon mixing with acid.

### BEST MODE(S) FOR CARRYING OUT THE INVENTION

International Patent Application PCT/AU2018/050310 (WO 2018/184067), the entire content of which is incorporated herein by reference, describes a method for preparing a leach feed material, the method comprising the steps of:
passing an ore or concentrate containing vanadium and iron to a reduction step to form a reduced ore or concentrate; and
passing the reduced ore or concentrate to a ferric leach step to produce a ferric leachate containing iron and a ferric leach residue containing vanadium,
   wherein the ferric leach residue is suitable for use as the leach feed material for extracting and recovering vanadium. In one form of that invention the ore or concentrate contains titanium in addition to vanadium and iron.

The reduction step is preferably conducted using a carbon reductant. Preferably, the carbon reductant is coke. More preferably, the concentration of coke, expressed as a ratio to the stoichiometric amount of carbon required for iron reduction, is between about 0.8 to 6.5. Still preferably, the concentration of coke is between about 2.5 to 5.

Without being bound by theory, the carbon:sample ratio, which is referred to as a ratio of the stoichiometric amount of carbon, is calculated by using the average composition of a titanomagnetite, which for example may be 4FeO.3Fe₂O₃.2TiO₂, together with the following reactions:

4FeO₍ₛ₎+4C₍ₛ₎→4Fe₍ₛ₎+4CO_{(g)}, and

3Fe₂O₃₍ₛ₎+9C₍ₛ₎→6Fe₍ₛ₎+9CO_{(g)}.

From these reactions and the composition of the titanomagnetite, the stoichiometric ratio of carbon is 0.153 (mass of carbon:mass of concentrate).

The reduction step is described as being conducted at a temperature range of between about 900° C. to 1200° C. More preferably, the reduction step is conducted at a temperature range of between about 1000° C. to 1100° C. The residence time of the reduction step preferably ranges about 1 to 3 hours. More preferably, the residence time of the reduction step is about 2 hours.

In one embodiment, the reduction step is conducted using reformed natural gas.

Preferably, the percentage of metallised iron in the reduced ore or concentrate is between about 50 to 100%.

The ferric leach step is preferably conducted with ferric chloride. Preferably, the concentration of ferric chloride ranges between about 10 to 40% w/w. More preferably the concentration of ferric chloride ranges between about 25 to 35% w/w. Still preferably, the concentration of ferric chloride is about 28% w/w.

Still preferably, the ferric leach step is conducted at a temperature ranging between about 60° C. to 110° C. under atmospheric pressure. More preferably, the ferric leach step is conducted at a temperature ranging about 60° C. to 80° C. under atmospheric pressure. The residence time of the ferric leach step preferably ranges between about 1 to 5 hours. More preferably, the residence time ranges between about 1 to 3 hours.

The solids content during the ferric leach step preferably ranges between about 3 to 20% w/w. More preferably, the solids content ranges between about 3 to 14% w/w, or still preferably 4 to 5% w/w.

It will be appreciated by those skilled in the art that the solids content during the ferric leach step will be dependent on the amount of reduced iron in the reduced ore or concentrate and the solubility of any ferrous chloride that is formed during the ferric leach step.

In one embodiment of the invention described in International Patent Application PCT/AU2018/050310 (WO 2018/184067), the method further comprises the step of:
passing the ferric leach residue to an acid leach step to produce an acid leachate containing vanadium and an acid leach residue.

Preferably, that acid leach residue contains titanium.

The acid leach step is preferably conducted using hydrochloric (HCl) acid. More preferably, the concentration of HCl acid ranges between about 15% to 32% (w/w). Still preferably, the concentration of HCl acid ranges between about 15% to 20% (w/w).

The acid leach step may be conducted under atmospheric pressure or under pressure. The acid leach step under atmospheric pressure is preferably conducted at a temperature ranging between about 25° C. to 100° C. Still preferably, the acid leach step under atmospheric pressure is preferably conducted at a temperature ranging between about 60° C. to 80° C.

In one form of that invention, the percentage of metallised iron in the reduced ore or concentrate preferably ranges between about 50 to 70% for an acid leach step conducted under atmospheric pressure, or between about 70 to 100% for an acid leach step conducted under pressure.

The acid leach step when conducted under pressure is preferably conducted at a temperature ranging between about 120° C. to 180° C., more preferably a temperature ranging between about 140° C. and 160° C., and still preferably at a temperature of about 150° C.

The residence time of the acid leach step conducted under atmospheric pressure preferably ranges between about 0.5 to 10 hours. More preferably, the residence time of the acid leach step under atmospheric pressure ranges between about 6 and 8 hours.

Preferably, the acid leach step conducted under pressure has a residence time ranging between about 0.5 to 4 hours. More preferably, the acid leach step conducted under pressure has a residence time ranging between about 3 to 3.5 hours.

The solids content during the acid leach step is preferably ranging between about 10 to 30% w/w. More preferably, the solids content during the acid leach step ranging between about 10 to 15% w/w. Still preferably, the solids content during the acid leach step is about 11% w/w.

It will be appreciated by those skilled in the art that the conditions of the acid leach step, for example the concentration of HCl acid, the residence time and the solids content, are adjusted to minimise the free acid at the end of the acid leach step. Preferably, the free acid concentration at the end of the acid leach step ranges between about 10 to 40 g/L.

In accordance with the present invention there is provided a method for the production of titanium dioxide. The method comprises a concentrated sulfuric acid digest of a titanium containing material, for example a leach residue. The leach residue may be, for example, the product of a leach of a titanomagnetite-type ore in hydrochloric acid as described hereinabove. The method of the present invention further comprises a weak sulfuric acid leach of the product of the sulfuric acid digest. A “black liquor” is thereby produced, containing, for example, about 80 g/L Ti, 8 g/L Fe, 0.5 g/L V and a free acid value of around 440 g/L. Recovery of titanium into the black liquor is in excess of 98% with about 79% of the iron and 90% of the vanadium also recovered into the black liquor from the leach residue.

Preferred conditions for the recovery of titanium by way of the process of the present invention were achieved with a first digestion at 190° C. for three hours using a mix of leach residue and concentrated sulfuric acid in a ratio of 1:1.27 (g/g). For the current leach residue, which has an assay of 67.3% TiO₂, this calculates to an acid requirement for the digest of 1.9 g of concentrated H₂SO₄ for every gram of TiO₂ content in the sample.

Then the digest residue is further leached with dilute, for example 6%, H₂SO₄ acid at about 60° C. for about 15 hours (20% solids in a shaking incubator) to obtain the black liquor. Solid liquid separation may be achieved by way of simple filtration.

Some dilution of the acid at the start of the digest is indicated to generate sufficient heat to initiate a potentially autothermic process. Comparative thermal analysis scans of acid slurries of ilmenite (which is known to proceed autothermically via the sulfate route) and the leach residue produced as described hereinabove indicate similar heat generation in the initial mixing stage and suggests an autothermic digestion reaction is also possible for the titanium containing leach residue produced as described hereinabove.

Sighter tests were also completed to ascertain if the titanium could be recovered from the black liquor and to provide indicative values for grade and recovery. Titanium was recovered from the black liquors by hydrolysis and a fine (p80 ˜10-12 μm) white powder with a grade of 74.2% TiO₂ obtained, titanium recovery was 80%. Calcination (1000° C.) of the hydrolysed precipitate gave a mass loss of 22% indicating a final TiO₂ grade of 95%.

The raw titanium dioxide so produced may be subjected to surface treatment so as to provide a product with specifications desired of a titanium pigment product.

The method for the preparation of titanium dioxide pigment of the present invention will now be described with reference to the following non-limiting example.

### Example

The method has been conducted using concentrate from the Applicant's Mt Peake ore body, that concentrate having a relatively coarse particle size distribution (˜p80 of 150 μm) and an assay composition close to that anticipated for a proposed commercial plant.

As described above in respect of the disclosure of International Patent Application PCT/AU2018/050310 (WO 2018/184067), the concentrate was subjected to a reductive roast and ferric chloride leach to first remove the bulk of the iron from the sample. The ferric chloride leach residue was treated in a pressure leach using hydrochloric acid (20% HCl, 20% solids) at 150° C. for three hours. The residual leach solids were separated from the leach liquor, washed and dried to obtain a pressure leach residue.

Leach residues prepared from this concentrate were the primary feed materials used to explore the potential of the method of the present invention to recover titanium from the Applicant's concentrate.

Titanium recovery by way of the method of the present invention was performed using a concentrated sulfuric acid digest followed by a low temperature (60° C.) dilute sulfuric acid (6%) leach to obtain a pregnant or ‘black’ liquor.

The black liquor, high in dissolved titanium, was then hydrolysed to precipitate a hydrated titanium oxide, which was then calcined to recover a TiO₂ product.

The following is a description of specific process steps utilised in carrying out the method of the present invention:
1. A sample was prepared from a concentrate using roasting, ferric chloride leaching and pressure leaching in HCl, as described hereinabove;
2. Around 50 g of leach residue was weighed accurately into a 400 mL tared evaporating basin;
3. The sample was placed in a fume hood and concentrated sulfuric acid (88-98%) added slowly to the sample with constant stirring using a glass/plastic rod;
4. The homogenous slurry/basin then transferred to a Birlec™ furnace preheated to the desired temperature. The furnace was vented to allow fume extraction of the off gases;
5. The mixture was digested at various temperatures and times prior to cooling to 60° C.;
6. Dilute sulfuric acid (6%) was slowly added to the digest residue with gentle stirring (glass or plastic rod) until a dilute slurry was obtained;
7. The basin then placed inside a laboratory oven (shaking incubator) at 60° C. with mixing for the first 2 hours. The sample then left overnight at temperature;
8. The leach liquor was recovered by centrifuge (in early tests) or filtration (latter tests) and the mass and SG of the liquor recorded (Anton Paar DMA™35).
9. The residual solids were washed with de-ionised water (repulped) and refiltered;
10. The washings repeated and the mass and liquor SG recorded for each; and
11. The final washed solids were transferred to a glass beaker and dried overnight at 105° C. The final dry mass was recorded.

The free acid of the leach and wash liquors were determined by caustic titration (using EDTA) and the liquors assayed for their metal content via Inductively Coupled Plasma (ICP). Solid residue assays were completed by x-ray fluorescence (XRF) and also alkali fusion/ICP. Metal recoveries and mass balances were determined from both the liquor and residue assays.

The titanium was recovered from the sulfuric acid leach liquors (the black liquor) by way of hydrolysis, as outlined by Grzmil B. U. and Bogumil K. “Hydrolysis of titanium Sulfate compounds.” Chemical papers—Slovak Academy of Sciences February 2008.

A portion of the Black liquors were taken (100-150 g) and weighed accurately into a small beaker and placed on a hot plate (˜80° C.).

From the free acid titration data the volume of water required to dilute the black liquor sample to achieve a final free acid of 150 g/L or less, was calculated (˜300-400 mL). This volume of de-ionised (DI) water was added to a tared 800 mL beaker and heated on a stirrer-hot plate to >80° C.

At temperature (80-90° C.) the black liquor was added dropwise into the stirred hot water. The dilution of the black liquor is exothermic and the hydrolysis reaction is completed near boiling. The black liquor was added over 30-40 minutes and the stirred mixture maintained at 90° C. for 3 hours. Upon cooling the solution was allowed to settle and the final mass recorded.

Solid liquid separations were completed by centrifuge and the precipitate washed twice with DI water and the mass and liquor SG recorded for the leach liquor and all washes. The washed solids dried overnight at 105° C.

The concentrate obtained from the Applicant's Mt Peake ore body, described hereinabove, was treated via reductive roasting, ferric chloride and pressure leaching, also described above, to produce the leach residues on which the remainder of the recovery tests for titanium were conducted. The major elemental assays of the concentrate from the Applicant's Mt Peake ore body are given Table 1 below.

TABLE 1

| | TiO₂ | Ti | Fe | V | SiO₂ |
|---|---|---|---|---|---|
| Sample | (%) | (%) | (%) | (%) | (%) |
| Conc. ex. Nagrom | 16.6 | 9.94 | 52.2 | 0.613 | 4.54 |

Roasting of the concentrate was completed in three campaigns with a total of 17 batches of 300 g each in a rotary pot furnace at around 1050-1100° C. for 2 hours. The first campaign was completed with a carbon stoichiometry of 0.8 and only achieved an iron removal rate of 51%. This was lower than desired and the two subsequent campaigns were completed with a carbon stoichiometry of 1.0. This produced a more satisfactory iron recovery rate near 80%.

The ferric chloride leach residues became feed to the pressure leach. Two batches were leached with 20% HCl at 16% solids, 150° C., and 400 kPa for 3 hours. The slurry filtered and the leach liquor and washed solids assayed to obtain metal recovery data and a mass balance. A summary of the assays from material at each stage are provided below in Table 2 (wherein FCLR indicates ferric chloride leach residue, and pTLR indicates pressure leach residue).

TABLE 2

| | TiO₂ | Fe | V |
|---|---|---|---|
| Sample | (%) | (%) | (%) |
| Nagrom conc. | 16.6 | 52.2 | 0.613 |
| Roast comp. | 19.3 | 60.31 | 0.716 |
| FCLR₄₅₅ | 32.7 | 32.97 | 1.19 |
| pTLR1 | 67.1 | 1.56 | 0.063 |
| pTLR2 | 67.3 | 1.91 | 0.066 |
| pTLR3 | 70.9 | 1.73 | 0.297 |

Initial sulfuric acid digests for the recovery of titanium were carried out on ferric chloride and pressure leach residues (TLR), and the bulk of the leach test work was performed on the pressure leach residues (PTLR) derived from the concentrate from the Applicant's Mt Peake ore body. Some sulfuric acid digests on ferric chloride leach residues (FCLR, feed to the pressure leach) were also completed to obtain comparative data.

The analysis of the major elements in the various feeds are summarised in Table 3 below. The residue TLR was fine (P₈₀<45 μm) whilst the PTLR derived from the coarser concentrate from the Applicant's Mt Peake ore body indicated a P₈₀ of about 125 μm.

TABLE 3

| | TiO₂ | Ti | Fe | V | SiO₂ | Al₂O₂ |
|---|---|---|---|---|---|---|
| Sample | (%) | (%) | (%) | (%) | (%) | (%) |
| TLRₚₚ ICP | 61.8 | 37.0 | 4.23 | 0.206 | 17.21 | |
| TLRₚₚ XRF | 61.9 | 37.1 | 4.50 | 0.210 | 19.01 | 2.1 |
| FCLR | 33.4 | 20.0 | 32.64 | 1.24 | 9.04 | 5.36 |
| PTLR-1 | 67.1 | 40.2 | 1.56 | 0.06 | 19.72 | 1.88 |
| PTLR-2 | 67.3 | 40.3 | 1.1 | 0.07 | 18.59 | 1.8 |
| PTLR-3 | 70.9 | 42.5 | 1.73 | 0.297 | 17.08 | 1.06 |

Initial digestion trials were completed to assess the methodology using feeds of ferric chloride leach residue (FCLRpp) and pressure leach residue (TLRpp) from a pilot plant operated by the Applicant, having the fine sizing noted above, being P₈₀<40 μm.

Duplicate samples of FCLRpp (50 g) were mixed with concentrated sulfuric acid (117 g) and heated to 300° C. for 4 hours. The resulting cake cooled and leached with water (800 mL of de-ionised) at 80° C. for 2 hours. The results from these trials (S19-S1, S2) are summarised in Table 4 below.

TABLE 4
Summary of Initial Trials

| | | Recovery % (via liq) | | | Recovery % (via Δ solids) | | |
|---|---|---|---|---|---|---|---|
| | | TiO₂ | Fe | V | TiO₂ | Fe | V |
| Trial# | Feed | (%) | (%) | (%) | (%) | (%) | (%) |
| S19 S1 | FCLRₚₚ | 31.8 | 95.8 | 101 | 35.9 | 92.6 | 95.1 |
| S19 S2 | FCLRₚₚ | 32.9 | 97.1 | 97.3 | 38.6 | 92.6 | 94.7 |
| S19 S3 | TLRₚₚ | 50.7 | 85.7 | 69.4 | | | |
| S19 S4 | TLRpp | 35.6 | 68.8 | 56.0 | | | |

The leaching of titanium under these experimental conditions yielded poor results with recoveries of 32-38%. A similar digest-leach was attempted on the leach residue from the pilot plant TLRpp using 100 g of sample and 200 g of acid digested at 280° C. for 4 hours. The leach was modified to use less acid (200 mL of 50% sulfuric over 2 hours) and the filtered residues then washed twice with 50% acid. This was an attempt to maintain the leached titanium in solution (TiOSO₄ readily ppt TiO₂ if diluted) and to recover any soluble titanium trapped in the solids. This method obtained an improved titanium recovery of 51% (S19 S3 Table 4). An additional 3 hour digest at 250° C., leached with 6% acid over 2 hours without residue washing (S19 S4 Table 4) reverted back to a titanium recovery of 36%.

It was determined to adopt modest digestion temperatures with longer leach times (using 6% acid) and multiple residue washings. This modified digest-leach was used to recover titanium from the pressure leach residue produced from the Applicant's Mt Peake concentrate (PTLR-1).

Duplicate samples (50 g) were mixed with concentrated sulfuric acid (˜100 g) and digested at 250° C. for 3 hours. The resulting cake cooled and leached with diluted sulfuric acid (200 g of 6%) for 15 hours at 60° C. (shaker incubator). The leach liquor separated from the solids and assayed to determine the amount of titanium recovered into solution. The solid residue washed (×4 with 6% H₂SO₄), dried and assayed to produce a mass balance. The results from this trial are summarised in Table 5 below. The calculated recovery data is indicated for both XRF and ICP analyses and includes metal recovery from the washing stages.

TABLE 5

| | Recovery % (via liq) | | | Recovery % (via Δ solids) | | |
|---|---|---|---|---|---|---|
| | TiO₂ | Fe | V | TiO₂ | Fe | V |
| Sample | (%) | (%) | (%) | (%) | (%) | (%) |
| S19 S5 | 102 | 81.4 | 91.8 | 98.5^{a} | 79.0^{a} | 91.5^{a} |
| | | | | 98.4^{b} | 79.6^{b} | 91.1^{b} |
| S19 S6 | 98.1 | 78.3 | 97.9 | 98.9^{a} | 78.9^{a} | 94.9^{a} |
| | | | | 98.8^{b} | 78.9^{b} | 94.5^{b} |

^{a}Assays via XRF
^{b}Assays via fission/ICP

This procedure used longer leach times with dilute acid to extract and stabilise the titanium in solution. Along with residue washing this achieved a titanium recovery from the PTLR-1 in excess of 98%. This high recovery for titanium was confirmed in duplicate by both liquor and solid assays, with mass balances in very good agreement.

Although most of the iron and the vanadium were previously leached from the sample in prior processing steps described hereinabove, this procedure also achieved high leach recoveries of these residual metals (˜80 and 90% for Fe and V respectively) from PTLR-1.

The sulfate leach liquors, referred to herein as ‘black liquor’, from the PTLR-1 were in fact dark green (commercial liquors are black). This is thought to be due to the lower iron content (4.5%) of the feed utilised. A summary of the leach liquor composition from both leach trials (neat leach liquor) are given in Table 6 below.

TABLE 6

| Leach | Ti | TiOSO₄ | Fe | V | Si | Mg | Al | FA | SG |
|---|---|---|---|---|---|---|---|---|---|
| liquor | (g/L) | (g/L) | (g/L) | (g/L) | (g/L) | (g/L) | (g/L) | (g/L) | (g/cc) |
| S19 S5 | 197 | 658 | 18.5 | 1.04 | 2.1 | 1.03 | 1.37 | 435 | 1.768 |
| S19 S6 | 80.2 | 268 | 7.77 | 0.46 | 1.77 | 0.43 | 0.64 | 440 | 1.426 |

Sample S19 S5 recovered only 76 g (46 mL) of the concentrated leach liquor (from the 200 mL of dilute acid added) due to a high evaporation rate during leaching and hence assayed metal grades in the leach liquor were high. The titanium recovered from the leach liquor accounted for around 46% of the titanium in the PTLR-1, whilst two washes (170 mL total) of the sulfate leach residue recovered most of the remaining 54% titanium from the entrained liquor.

Losses due to evaporation were minimised in the second leach (S19 S6) and a total of 232 g (163 mL) of green leach liquor was recovered with a titanium grade of around 80 g L-1. The recovered leach liquor contained 70% of the titanium in the PTLR-1, which increased to >97% recovery after two washes (2×120 mL) with de-ionised water.

Titanium recovery from these initial trials was excellent and as such two additional sulfate digests were completed for confirmation. Titanium recovery trials (S19-9, 10) obtained titanium recoveries in excess of 99%, as shown in Table 7 below, and confirmed the high recovery data obtained in the earlier trials.

A series of trials was then completed in an attempt to optimise some of the experimental conditions and to reduce reagent consumption, again shown in Table 7.

Digest temperatures (11-13) were reduced in 25° C. steps from 200° C. down to 150° C. to determine the minimum digestion temperature required. Digestions above 175° C. maintained titanium recoveries above 97% but decrease to 89% when digests temperatures dropped to 150° C. A digest target temperature of around 190° C. is thought to be preferred. As such, most of the subsequent trials to optimise other variables were conducted at 190° C. or higher.

TABLE 7

| | | H₁SO₄ | H₁SO₄ | Acid/ | | | Ti | |
|---|---|---|---|---|---|---|---|---|
| | PTLR-1 | @ 98% | Diluted | feed | Temp | Time | recovery | |
| S19-# | (g) | (g) | (%) | (g/g) | (° C.) | (hrs) | (%) | Comments |
| 5 | 50 | 102 | 98 | 2.00 | 250 | 3 | 95.5 | 4 washes |
| 6 | 50 | 100 | 98 | 1.97 | 250 | 3 | 98.9 | 7 washes |
| 7 | 50 FCLR | 200 | 98 | 3.93 | 250 | 3 | 85.9 | FCLRₚₚ |
| 5 | 50 FCLR | 100 | 98 | 1.96 | 250 | 3 | 71.7 | FCLRₚₚ |
| 9 | 50 | 100 | 98 | 1.96 | 250 | 3 | 95.7 | Confirms |
| 10 | 50 | 100 | 98 | 1.96 | 250 | 3 | 99.0 | Confirms |
| 11 | 55 | 100 | 98 | 1.96 | 200 | 3 | 97.8 | Temp trial |
| 12 | 50 | 100 | 98 | 1.97 | 175 | 3 | 98.9 | ″ |
| 13 | 50 | 100 | 98 | 1.95 | 150 | 3 | 89.4 | Low temp |
| | PTLR-2 | | | | | | | |
| 14 | 50 | 50 | 90 | 0.98 | 200 | 3 | 38.3 | Acid trial |
| 15 | 50 | 55 | 88 | 1.08 | 190 | 3 | 68.3 | ″ |
| 16 | 50 | 55 | 92 | 1.08 | 190 | 3 | 68.4 | ″ |
| 17 | 50 | 45 | 88 | 0.88 | 190 | 3 | 27.2 | ″ |
| 18 | 50 | 45 | 92 | 0.88 | 190 | 3 | 27.3 | ″ |
| 19 | 50 | 45 | 92 | 0.88 | 210 | 3 | 17.9 | Temp + acid |
| 20 | 50 | 55 | 88 | 1.08 | 210 | 3 | 42.3 | ″ |
| 21 | 50 | 45 | 88 | 0.88 | 210 | 3 | 29.1 | ″ |
| 22 | 50 | 55 | 92 | 1.08 | 210 | 3 | 60.0 | ″ |
| 23 | 50 | 75 | 88 | 1.46 | 190 | 3 | 95.1 | ″ |
| 24 | 50 | 65 | 88 | 1.26 | 190 | 3 | 93.2 | ″ |
| 25 | 50 | 75 | 92 | 1.47 | 210 | 3 | 90.5 | ″ |
| 26 | 50 | 65 | 92 | 1.26 | 210 | 3 | 94.7 | |
| 27 | 50 | 85 | 98 | 1.67 | 175 | 3 | 81.9 | Low temp″ |

The impact of total acid addition and acid concentration on the titanium recovery data was explored in trials 14-22 of Table 7. The acid additions for these digestions trials were based on the titanium content of the feed material. However, XRF assays for this batch of feed (PTLR-2) were not available and the acid values were calculated based on a single ICP assay from the pressure leach data (61% TiO₂).

The trial results clearly showed a marked decrease in the titanium recovery for all of these tests and strongly indicated that the acid addition rates were insufficient for the titanium content of this feed. XRF data returned an assay of 67.3% TiO₂ confirming inadequate acid levels for these tests and thus they were repeated (23-27) with re-calculated higher acid levels. This resulted in titanium recovery values in excess of 90% for all the acid trials with the exception of trial 27 (81.9%). This trial contained more acid than the others but was digested at a lower temperature of 175° C.

The acid trials suggest a minimum of 1.9 g of H₂SO₄ (100%) is required for every gram of TiO₂ content in the feed sample. Thus, for a 50 g sample with 67.3% TiO₂ a minimum acid (100%) addition of 64 g (or 65 g of 98% H₂SO₄) is required to achieve a high (>90%) titanium recovery. The minimum acid addition for trials 23-27 was 65 g of commercial 98% sulfuric (Trials 24 and 26). The maximum acid addition for trials 14-22 was only 55 g H₂SO₄ (or 1.6 g H₂SO₄ (100%) per gram of TiO₂).

As noted hereinabove, sulfate digestion and leaching of titanium from ilmenite is autothermic and no additional heat input is required to complete the digest. The pressure leach residue, the starting material for the method of the present invention, however contains more TiO₂ than ilmenite but significantly less iron. It was consequently not known if the starting leach residue, as a feed to the method of the present invention, might produce sufficient heat by way of the initial exothermic reaction to complete the digest without additional heating.

Samples of PTLR-3 (50 g) were mixed with sulfuric acid (65 g) and water (10 g) in a small ceramic dish coupled with a glass sheathed thermocouple. The initial temperature rise upon mixing was recorded and then the sample slowly heated in an attempt to monitor any initiation of an exothermic reaction.

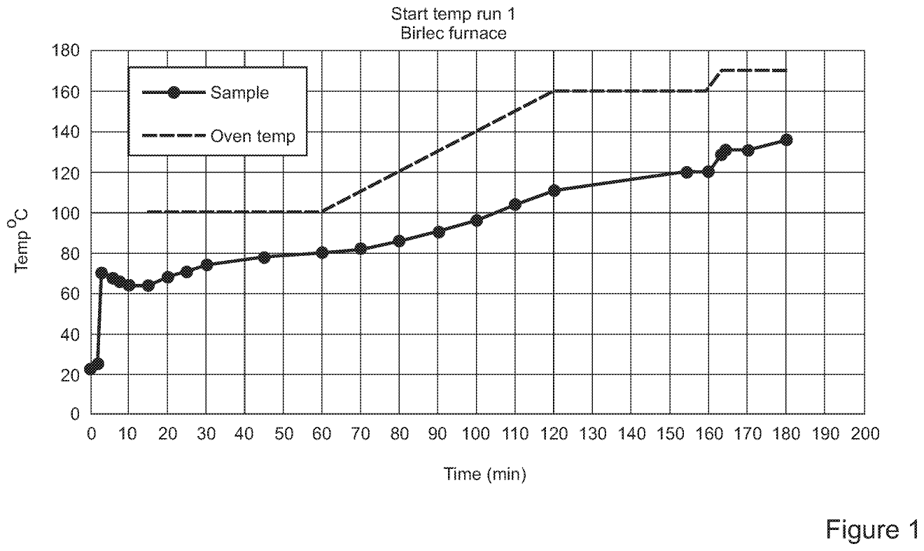

The first trial was completed in the large furnace used for the digestion-leach work. This furnace has a large thermal mass and the monitored sample heating rate lagged significantly behind that of the furnace control thermocouple, as can be seen in FIG. 1. This resulted in a sample temperature plot with little detail and a curve which broadly followed the kiln profile.

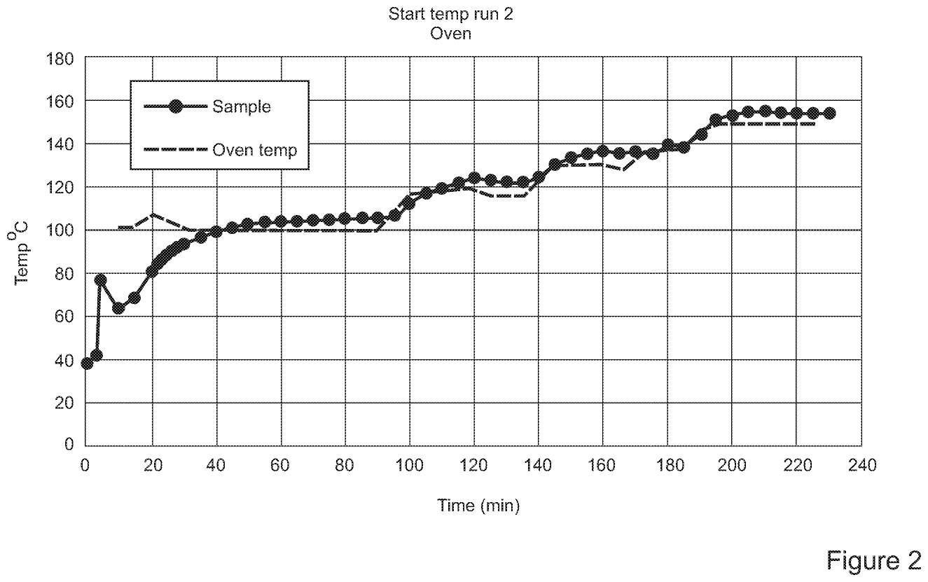

The second trial, as shown in FIG. 2, was a repeat using a much smaller fan forced oven with a rapid temperature response. The sample produced a similar initial temperature rise upon mixing with acid and water (20-76° C.) and was then placed in the oven. The sample temperature increased to match the oven at 100° C. after 40 minutes but no significant temperature deviation was observed in the sample other than that of the oven set point increases.

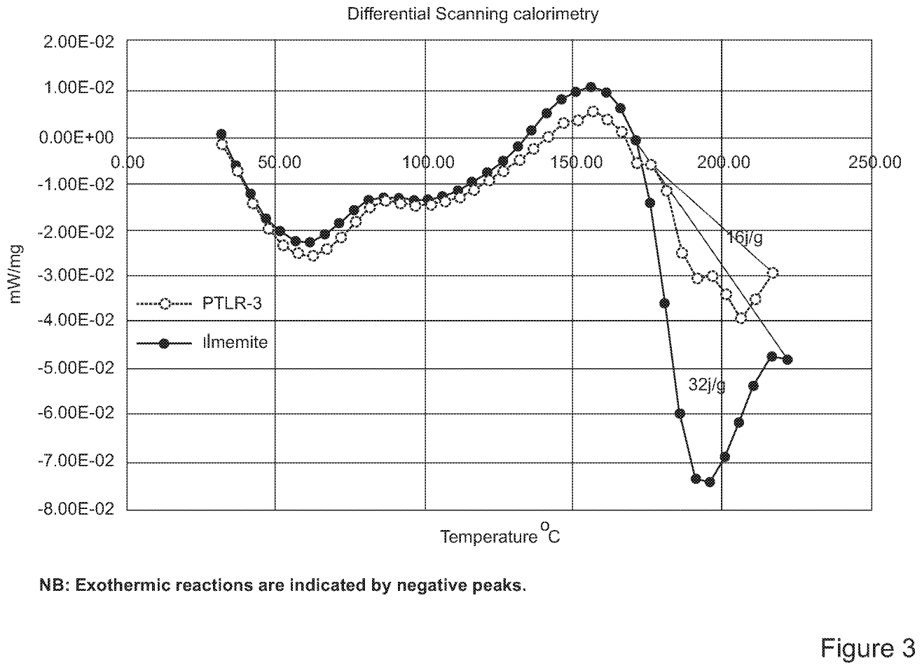

To improve the sensitivity of the test and hopefully detect any exothermic reactions a small sample of PTLR-3 was analysed by Thermal Analysis, as shown in FIG. 3. The acid water mix was prepared separately and cooled with ice to remove the initial heat from dilution. The acid then mixed with the pressure leach residue and placed in a small ceramic sample holder in the thermogravimetric differential scanning calorimeter (TGA/DSC) and heated at 2.5° C./min to 220° C. A similar analysis on a sample of ilmenite was also completed to provide reference data for comparison.

Even without the initial heat of dilution the PTLR-1 and ilmenite both exhibit small exothermic reactions upon mixing with acid (31-81° C.). The exothermic peaks start the return back to the baseline but appear to be arrested at around 80° C. in both samples. This suggests an additional exothermic reaction occurs near this temperature. Both samples return to the baseline around 135° C. (small absorption of heat) and then produce large exothermic reactions (digestion) between 160-210° C.

The DSC traces for both ilmenite and PTLR-3 are very similar with the largest variance the amount of heat released in the exothermic digestion peak between 160-210° C. The energy released by the ilmenite (based on the peak areas of the incomplete reactions) appears to be approximately double that of the PTLR-3 sample.

As the digestion reaction starts at around 160° C. the initial exothermic reactions would need to heat the mixtures to this temperature to initiate the autothermic digestion process. The low temperature portions of the plots have very similar profiles and as ilmenite is known to proceed autothermically it is considered very likely the PTLR will also do so.

Recovery of the titanium from the leach liquors was determined by the hydrolysis of a small sub-portion of the leach liquors to obtain hydrated titanium oxide (TiO(OH)₂). The initial trial on the leach liquor (S19H1 using leach liquor S19 S5) was conducted by simply boiling the liquor to initiate the hydrolysis. This yielded small amounts of precipitate but ultimately produced gels which did not facilitate hydrolysis or allow solid liquid separations. A procedure to dilute the leach liquors into hot water to a target final free acid value (Grzmil et al., 2008) was adopted to overcome these issues.

The first (failed) hydrolysis trial used a mixture of the leach liquor (40 g) and the first wash solution (180 g) to obtain a solution of the approximate composition suitable for hydrolysis, as set out in Table 8 below. The initial boiling of this solution resulted in a gel, from which no precipitate was collected. Subsampling of the liquor during the boiling phase (˜45 g) was an attempt to monitor the progress of the hydrolysis (via changes in the liquor assays) but ceased upon the formation of a gel.

TABLE 8

| | Leach | | To | | | | |
|---|---|---|---|---|---|---|---|
| | liquor | SG | Hydrolysis | Vol | Ti | TiOSO₄ | FA |
| S19 S5 | (g) | (g/cc²) | (g) | (mL) | (g/L) | (g/L) | (g/L) |
| LL1 | 76.48 | 1.768 | 39.96 | 22.6 | 197.1 | 658.2 | 435 |
| W1 | 218.55 | 1.217 | 179.99 | 147.9 | 51.0 | 170.2 | 213 |
| W2 | 61.55 | 1.083 | | | 15.9 | 53.0 | 78 |
| W3 | 44.96 | 1.058 | | | 5.3 | 17.5 | 69 |
| W4 | 58.62 | 1.049 | | | 1.5 | 4.9 | 66 |
| Total avg | | 1.29 | 219.95 | 170.5 | 70.34 | 235 | 242 |

This gelled sample was reconstituted back with the addition of water (50 mL). Around 114 g of liquor remained (with a free acid of 446 g/L) which was then treated using the method described by Grzmil et al., 2008. The leach liquor was heated and then added dropwise to 225 g of hot DI water to recover the titanium via hydrolysis. The volume of hot water was calculated to target a final free acid value below 150 g/L.

Analysis of the two feed liquor streams and the 1 and 2 hr sub samples are given in Table 9 below. The mass balance was corrected for this subsampling. Thus the total input of titanium to the hydrolysis process was (4.45+7.54−1.411−2.027−0.036−0.108)−8.41 g (Table 12).

TABLE 9

| | Hydrolysis Feed liquor | | | Assays | | | Feed content | | |
|---|---|---|---|---|---|---|---|---|---|
| Source | Mass | SG | Vol | Ti | Fe | V | Ti | Fe | V |
| S19 S5 | (g) | (g/cc²) | (mL) | (g/L) | (g/L) | (mg/L) | (g) | (g) | (mg) |
| LL1 | 39.96 | 1.768 | 22.6 | 197.1 | 18.51 | 1040 | 4.45 | 0.24 | 23 |
| W1 | 179.99 | 1.217 | 147.9 | 50.97 | 4.526 | 246 | 7.54 | 0.67 | 36 |
| 1 hr sample | −23.08 | 1.3376 | 17.3 | 81.8 | 4.4 | 200 | −1.411 | −0.076 | −3.1 |
| 2 hr sample | −21.19 | 1.6522 | 12.8 | 158.1 | 8.5 | 400 | −2.027 | −0.110 | −4.5 |

The barren hydrolysis liquor, including a single wash (Table 10 below) retained around 1.68 g of titanium, which calculates to a titanium recovery of around 80% (Table 12). Similar calculations for the iron and vanadium yield a recovery of these metals into the precipitated solids of 18.8 and 4.5% respectively.

The analysis of the dried solid precipitate (Table 11) indicated at titanium grade of 44.5% which gives a titanium recovery via hydrolysis of 70.3%. Iron and vanadium calculated recoveries were 20.5 and 4.4%, respectively.

TABLE 10

| | Hydrolysis Barren liquor | | | Assays | | | Barren liquor content | | |
|---|---|---|---|---|---|---|---|---|---|
| Source | Mass | SG | Vol | Ti | Fe | V | Ti | Fe | V |
| S19 S5 | (g) | (g/cc²) | (mL) | (g/L) | (g/L) | (mg/L) | (g) | (g) | (mg) |
| LLI | 304.56 | 1.08 | 282.0 | 5.176 | 1.951 | 137 | 1.460 | 0.55 | 38.5 |
| WI | 63.22 | 1.027 | 61.6 | 3.569 | 0.564 | 26 | 0.22 | 0.035 | 1.6 |
| Total | 367.78 | | 343.6 | | | | 1.679 | 0.585 | 40.1 |

TABLE 11

| | Hydrolysis product Assays | | | | Hydrolysis Metal content | | |
|---|---|---|---|---|---|---|---|
| Source | Mass | Ti | Fe | V | Ti | Fe | V |
| S19 S5 | (g) | (%) | (%) | (%) | (g) | (g) | (mg) |
| | 13.29 | 44.5 | 1.11 | 0.014 | 5.91 | 0.15 | 1.86 |
| 1 hr sample | | | | | −0.036 | | |
| 2 hr sample | | | | | −0.108 | | |

TABLE 12

| | Feed content* | | | Barren liquor content | | | Hydrolysis product | | |
|---|---|---|---|---|---|---|---|---|---|
| Source | Ti | Fe | V | Ti | Fe | V | Ti | Fe | V |
| S19 S5 | (g) | (g) | (g) | (g) | (g) | (g) | (g) | (g) | (g) |
| S19 H1 | 8.41 | 0.72 | 0.04 | 1.579 | 0.585 | 0.040 | 5.91 | 0.15 | 0.002 |

| | | | | | | |
|---|---|---|---|---|---|---|
| Recovery % | 80.0 | 18.8 | 4.5 | 70.3 | 20.5 | 4.4 |

* [symbol] [symbol]
indicates data missing or illegible when filed

The hydrolysed product, a fine white powder, was calcined at 1000° C. to remove waters of hydration. The mass loss from the calcination step was 22%. Correcting for this mass loss the TiO₂ content of the calcined product calculates to around 95% (Table 13 below). The major contaminant appears to be iron (˜1.5%).

TABLE 13

| Uncalcined | | | Calcined | | |
|---|---|---|---|---|---|
| | Ti (%) | TiO₂ (%) | LOI (%) | Ti (%) | TiO₂ (%) |
| SI9 H1 | 44.5 | 74.2 | 22 | 57.0 | 95.1 |

The calcination of the product gives a mass loss of 22%. The expected loss of 1 mole of water equates roughly to 18% and suggest either additional water is present or the decomposition of other metal hydroxides.

The recovery of titanium from the second leach liquor (S19 S6) was a simpler process, utilising only the primary leach liquor and water to recovery the titanium by the Grzmil et al., 2008 process. A sample of the leach liquor (150 g, 105.2 mL) was heated and added dropwise to hot DI water (397 mL) over a period of 40 minutes. The volume of water required was determined from the initial free acid content of the leach liquor (446 g/L) to obtain a final free acid value below 100 g/L. The hydrolysis liquor volumes and assays are given in Table 14 below.

TABLE 14

| | Hydrolysis Feed liquor | | | Assays | | | Feed content | | |
|---|---|---|---|---|---|---|---|---|---|
| Source | Mass | SG | Vol | Ti | Fe | V | Ti | Fe | V |
| S19 S6 | (g) | (g/cc²) | (mL) | (g/L) | (g/L) | (mg/L) | (g) | (g) | (mg) |
| LL2 | 150 | 1.4255 | 105.2 | 80.23 | 7.766 | 463 | 8.44 | 0.82 | 49 |
| DI | | | 397 | | | | | | |

The leach liquor assay was 80 g/L Ti with a free acid concentration of 446 g/L. The target free acid (<100 g/L) concentration was lowered with the intent to simply obtain a product of sufficient recovery and grade for analysis.

The barren hydrolysis liquor upon cooling was separated from the precipitated solids and assayed. The precipitated solids were washed twice with DI water and both solids and wash waters assayed. A summary of the barren hydrolysis liquors is given in Table 15 below. The precipitate assays given in Table 16, also below.

TABLE 15

| | Hydrolysis Barren liquors | | | Assays | | | Barren liquor content | | |
|---|---|---|---|---|---|---|---|---|---|
| Source | Mass | SG | Vol | Ti | Fe | V | Ti | Fe | V |
| S19 S6 | (g) | (g/cc²) | (mL) | (g/L) | (g/L) | (mg/L) | (g) | (g) | (mg) |
| LL1 | 472.5 | 1.08 | 437.5 | 3.168 | 1.411 | 0.092 | 1.39 | 0.62 | 41 |
| W1 | 146.5 | 1.0156 | 144.3 | 0.768 | 0.244 | 0.015 | 0.11 | 0.04 | 2 |
| W2 | 113.6 | 1.0044 | 113.1 | 0.152 | 0.043 | 0.035 | 0.02 | 0.00 | 0 |
| Total | 732.67 | | 694.9 | | | | 1.51 | 0.66 | 43 |

TABLE 16

| | Hydrolysis product Assays | | | Hydrolysis Metal content | | | |
|---|---|---|---|---|---|---|---|
| Source | Mass | Ti | Fe | V | Ti | Fe | V |
| S19 S6 | g | (%) | (%) | (%) | (g) | (g) | (mg) |
| | 14.62 | 44.48 | 0.87 | 0.01 | 6.50 | 0.13 | 1 |

The titanium recovery data from both the solution assays and the solid are given in Table 17 below. The mass balance data improved from the previous trial and the overall recovery of titanium was slightly higher. The iron contamination appeared less but the titanium grade of the hydrolysis product (uncalcined) appeared to be very similar to the previous trial (˜44.5% Ti). The calcination of this product yielded a very similar mass loss value (22.6%) and a final TiO₂ purity the same as the initial (S19 H1) at around 95.9%.

As can be seen from the above description, sulfate digests of pressure leach residue, in accordance with the present invention, yielded black liquors containing around 80 g/L Ti, 8 g/L Fe, 0.5 g/L V and a free acid value of around 440 g/L. With two stages of washing the recovery of titanium into the leach liquors was in excess of 98%, with around 79% of the iron and 90% of the vanadium also recovered from the pressure leach residue.

Trials indicate the optimum conditions for the sulfate digestion were 190° C. for three hours using a mix of pressure leach residue and concentrated sulfuric acid in a ratio of 1:1.27 (g/g). The pressure leach residue gave an assay of 67.3% TiO₂ and thus calculations indicate that 1.9 g of concentrated H₂SO₄ (100%) is required for every gram of TiO₂ content in the sample.

Dilution of the acid to around 88-92% H₂SO₄ with water is recommended to initiate the exothermic reaction upon preparation of the slurry for digest. Upon completion of the digest, the black residue is repulped/leached in 6% H₂SO₄ acid at 60° C. for 15 hours. The black liquor is recovered by filtration and the solids washed (2× mass of initial feed with 6% H₂SO₄) to achieve high titanium recovery.

Trials indicated digestions below 180° C. exhibited a rapid decrease in titanium recovery as did insufficient acid additions (<1.9 g H₂SO₄ per gram of TiO₂). Feed samples with higher iron content (pressure leach residue=1.9% Fe) may also require additional acid if they vary significantly from the current pressure leach residue samples.

Comparative thermal analysis scans of the acid slurries of pressure leach residue and ilmenite indicate they both release similar amounts of heat in the initial mixing stage. This suggests the autothermic digestion reaction observed for ilmenite may occur with pressure leach residue and thereby it is envisaged that this may reduce or eliminate the need for external heating in the digestion stage.

Some initial recovery of titanium from the black leach liquors was achieved via hydrolysis. The titanium in the sulfate leach liquors were hydrolysed by dilution in hot water and a fine white powder with a grade of 74.2% TiO₂ obtained. Titanium recovery via hydrolysis was about 80%.

Calcination (1000° C.) of the product indicated a mass loss of 22%, which was slightly higher than the loss due to one mole of water (18%) and provided a calculated TiO₂ content of the calcined product of 95%.

The raw titanium dioxide so produced may be subjected to surface treatment so as to provide a product with specifications desired of a titanium pigment product.

Modifications and variations such as would be apparent to the skilled addressee are considered to fall within the scope of the present invention.

1. A method for the preparation of titanium dioxide, the method comprising the steps of:
(i) subjecting a titanium containing leach residue to a concentrated sulfuric acid digest step; and
(ii) in turn subjecting that residue to a leach in dilute sulfuric acid to obtain a black liquor from which titanium dioxide is in turn obtained,
wherein the leach residue is a residue from a hydrochloric leach of a titanomagnetite-type ore.

2. The method of claim 1, wherein the titanium dioxide is utilised in the preparation of a titanium dioxide pigment.

3. The method of claim 1, wherein the concentration of hydrochloric acid ranges between:
(i) about 15% to 32% (w/w); or
(ii) about 15% to 20% (w/w).

4. The method of claim 1, wherein a feedstock for the leach of the titanomagnetite-type ore is the product of a ferric leach.

5. The method of claim 1, a feedstock for the leach of the titanomagnetite-type ore is the product of a ferric leach, the ferric leach step having been conducted with ferric chloride.

6. The method of claim 5, wherein the concentration of ferric chloride ranges between:
(i) about 10 to 40% w/w;
(ii) about 25 to 35% w/w; or
(iii) about 28% w/w.

7. The method of claim 1, wherein the titanium containing leach residue has a P₈₀ of:
(i) ≤125 μm;
(ii) ≤45 μm; or
(iii) <40 μm.

8. The method of claim 1, wherein recovery of titanium into the black liquor is at least 98%.

9. The method of claim 1, wherein the digest step is conducted at a temperature of:
(i) greater than 175° C.; or
(ii) about 190° C.

10. The method of claim 1, wherein the digest step is conducted over a period of:
(i) between about 3 to 4 hours; or
(ii) about 3 hours.

11. The method of claim 1, wherein the mix of leach residue to concentrated sulfuric acid in the digest step is in the ratio of about 1:1.27 (g/g).

12. The method of claim 1, wherein at least 1.9 g of concentrated sulfuric acid is provided in the digest step (i) for every gram of TiO₂ in the titanium containing leach residue.

13. The method of claim 1, wherein the dilute sulfuric acid of the leach step (ii) is about 6% sulfuric acid.

14. The method of claim 1, wherein the leach step (ii) is conducted at about 60° C.

15. The method of claim 1, wherein the leach step (ii) is conducted for a period of about 15 hours.

16. The method of claim 1, wherein the leach step (ii) is conducted at about 20% solids.

17. The method of claim 1, wherein the black liquor is recovered from a slurry produced by the leach step (ii) by filtration, and the solids washed to recover titanium.

18. The method of claim 1, wherein the digest step (i):
(i) proceeds in an autothermic manner;
(ii) further comprises an initial dilution of the acid; or
(iii) further comprises an initial dilution of the acid to about 88-92% with water.

19. (canceled)

20. (canceled)

21. The method of claim 1, wherein the black liquor is passed to hydrolysis and calcination for the recovery of titanium dioxide.
